(19) United States
(12) Patent Application Publication
(10) Pub. No.: US 2009/0037520 A1
(43) Pub. Date: Feb. 5, 2009

(54) System and method for secure file transfer

(75) Inventor: Jeremy Michael Loffredo, Washington, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/881,956

(22) Filed: Jul. 30, 2007

(51) Int. Cl. G06F 15/16; G06F 17/30

(52) U.S. Cl. 709/203; 707/10; 707/E17.032

(57) ABSTRACT

A method for transferring files between a client system and a file server includes receiving a location associated with at least one data file to be uploaded to a file server and a recipient list that includes an electronic address associated with at least one intended recipient of the at least one data file. A communication channel is established between the client system and the file server, and the at least one data file is uploaded to a file transfer account associated with one or more of a sender or the at least one intended recipient. An electronic message is provided to the electronic address, the electronic message including an interactive link to the uploaded file. The user interface modifies the recipient list associated with the at least one data file after the at least one data file has been uploaded to the file transfer server.

### TECHNICAL FIELD

The present disclosure relates generally to file transfer systems and, more specifically, to a system and method for securely transferring, tracking, monitoring, and managing files over the Internet.

### BACKGROUND

Many modern businesses increasingly rely on the Internet to complement their private networks. For example, many organizations provide employees, customers, and other authorized users with remote access to information on their private networks by providing a secure connection that allows users with an Internet connection to securely access electronic documents and applications via a web interface. By leveraging the widespread availability of the Internet to create a virtual electronic work environment, these organizations may realize an increase in productivity, as employees, customers, and business associates may be able to securely share data with a plurality of users simultaneously, without having to commute to a common location or transmit across unsecured media (e.g., e-mail, etc.).

To facilitate remote data transfer, many organizations employ a centralized, Internet-accessible file transfer database. These file transfer databases typically employ file transfer software that allows authorized users to upload, download, modify, and otherwise access shared data files via the Internet. The file transfer software may support file transfer protocols, such as FTP and other file transfer methodologies. However, these file transfer techniques may present security concerns, as the file transfer database may be accessible to unauthorized Internet users. Moreover, these applications do not provide an integrated messaging service that allows authorized users to notify intended recipients that newly-posted files are available for download. Thus, in order to enable secure and efficient file transfer over public networks such as the Internet, applications and methods that enable authentication of authorized users and provide an integrated messaging service may be required.

At least one system has been developed for enabling secure data transfer using the Internet. For example, U.S. Patent Publication No. 2003/0177422 (“the '422 publication”) to Tararoukhine et al. describes a data transfer and management system that comprises a data encryption and transfer module. The module includes a first desktop window associated with a user computing system and second desktop window associated with a server computing system. Data may be moved to or from a user computing system to or from a server computing system through the use of first and second desktop windows. Each of the first and second desktop windows may be associated with a password, such that the step of moving the data from one window to the other may cause the data to be encrypted/re-encrypted from one password to the other.

Problems may arise when multiple windows are used to transfer data between a user system and a server system. For example, navigating between multiple windows to transfer data from the user system to the server system may be cumbersome for the user. Furthermore, requiring multiple passwords to encrypt and de-encrypt data, as described in the '422 publication, may necessitate the use of an additional password management module, which may increase the complexity of the data transfer module.

The presently disclosed system and method for secure file transfer via the Internet is directed toward overcoming one or more of the problems set forth above.

### SUMMARY OF THE INVENTION

In accordance with one aspect, the present disclosure is directed toward a method for transferring files between a client system and a file server. The method may include receiving, by a user interface of a client system, a location associated with at least one data file to be uploaded to a file server. The method may also include receiving, by a user interface of a client system, a recipient list that includes an electronic address associated with at least one intended recipient of the at least one data file. A communication channel may be established between the client system and the file server, and the at least one data file may be uploaded to a file transfer account associated with one or more of a sender or the at least one intended recipient of the at least one data file. The method may further include providing an electronic message to the electronic address associated with the at least one intended recipient, the electronic message including an interactive link to the uploaded file. The user interface may modify the recipient list associated with the at least one data file after the at least one data file has been uploaded to the file transfer server, in response to a sender modification request.

According to another aspect, the present disclosure is directed toward a file transfer interface. The interface may include a file selection portion communicatively coupled to a file database associated with a user computing system and configured to allow a user to select at least one file to be uploaded to a file transfer server. The interface may also include a recipient selection portion communicatively coupled to an electronic messaging directory and configured to allow the user to create, from the electronic messaging directory, a recipient list that includes at least one intended recipient of the at least one data file. The interface may further include an access portion communicatively coupled to the file transfer server. The access portion may be configured to display files uploaded by the user to the file transfer server, modify the recipient list associated with one or more files after the one or more files have been uploaded to the file transfer server, in response to a user command, and display a status of each of the files uploaded by the user.

### BRIEF DESCRIPTION OF THE DRAWINGS

FIG. 1 illustrates an exemplary file transfer environment, consistent with the disclosed embodiments;

FIG. 2A-2E each illustrate exemplary views of an interactive interface that facilitates secure file transfer processes within the file transfer environment of FIG. 1; and

FIG. 3 provides a flowchart depicting an exemplary method for secure file transfer, consistent with the disclosed embodiments.

### DETAILED DESCRIPTION

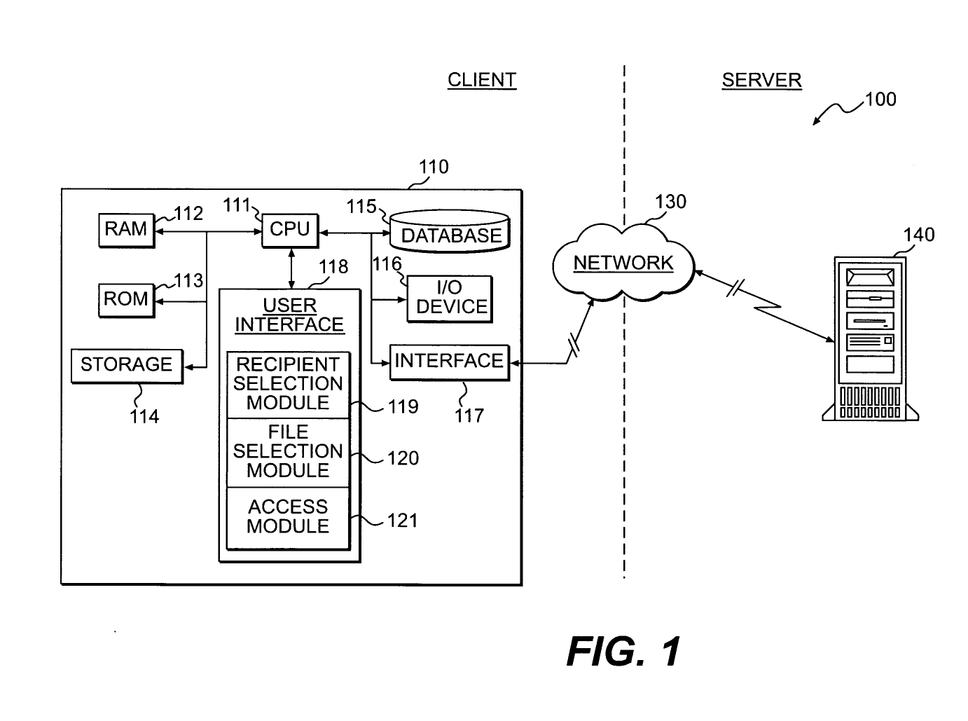

FIG. 1 illustrates an exemplary file transfer environment 100 in which processes and methods consistent with the disclosed embodiments may be implemented. File transfer environment 100 may embody any type of network that includes one or more computer systems communicatively coupled to a communication network 130. According to one exemplary embodiment, file transfer environment 100 may include at least one user computing system 110 associated with one or more users or groups of users of file transfer environment 100. File transfer environment 100 may also include a file transfer server 140 communicatively coupled to the at least one user computing system 110 via communication network 130. File transfer environment 100 may also include a web interface (not shown) that provides secure user access to certain features associated with file transfer server 140 via the Internet. For example, web interface may provide a secure platform that allows an external user to access a unique file transfer account stored in file transfer server 140.

User computing system 110 may include any type of processor-based system on which processes and methods consistent with the disclosed embodiments may be implemented. For example, as illustrated in FIG. 1, user computing system 110 may include one or more hardware and/or software components configured to execute software programs, such as software for facilitating secure data transfer between user computing system 110 and file transfer server 140. For example, user computing system 110 may include one or more hardware components such as, for example, a central processing unit (CPU) 111, a random access memory (RAM) module 112, a read-only memory (ROM) module 113, a storage system 114, a database 115, one or more input/output (I/O) devices 116, and a network interface 117. Alternatively and/or additionally, user computing system 110 may include one or more software components such as, for example, a computer-readable medium including computer-executable instructions for performing methods consistent with the disclosed embodiments. It is contemplated that one or more of the hardware components listed above may be implemented using software. For example, storage 114 may include a software partition associated with one or more other hardware components of user computing system 110. User computing system 110 may include additional, fewer, and/or different components than those listed above. It is understood that the components listed above are exemplary only and not intended to be limiting.

CPU 111 may include one or more processors, each configured to execute instructions and process data to perform one or more functions associated with user computing system 110. As illustrated in FIG. 1, CPU 111 may be communicatively coupled to RAM 112, ROM 113, storage 114, database 115, I/O devices 116, and network interface 117. CPU 111 may be configured to execute sequences of computer program instructions to perform various processes, which will be described in detail below. The computer program instructions may be loaded into RAM for execution by CPU 111.

RAM 112 and ROM 113 may each include one or more devices for storing information associated with an operation of user computing system 110 and/or CPU 111. For example, ROM 113 may include a memory device configured to access and store information associated with user computing system 110, including information for identifying, initializing, and monitoring the operation of one or more components and subsystems of user computing system 110. RAM 112 may include a memory device for storing data associated with one or more operations of CPU 111. For example, ROM 113 may load instructions into RAM 112 for execution by CPU 111.

Storage 114 may include any type of mass storage device configured to store information that CPU 111 may need to perform processes consistent with the disclosed embodiments. For example, storage 114 may include one or more magnetic and/or optical disk devices, such as hard drives, CD-ROMs, DVD-ROMs, or any other type of mass media device.

Database 115 may include one or more software and/or hardware components that cooperate to store, organize, sort, filter, and/or arrange data used by user computing system 110 and/or CPU 111. For example, database 115 may include a data file storage repository from which files may be selected for uploading and sharing via a file transfer server. It is contemplated that database 115 may store additional and/or different information than that listed above.

I/O devices 116 may include one or more components configured to communicate information with a user associated with user computing system 110. For example, I/O devices 116 may include a console with an integrated keyboard and mouse to allow a user to input parameters associated with user computing system 110. I/O devices 116 may also include a display including a graphical user interface (GUI) for outputting information on a monitor. I/O devices 116 may also include peripheral devices such as, for example, a printer for printing information associated with user computing system 110, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Network interface 117 may include one or more components configured to transmit and receive data via a communication network, such as the Internet, a local area network, a workstation peer-to-peer network, a direct link network, a wireless network, or any other suitable communication platform. In this manner, user computing system 110 and file transfer server 140 may communicate through the use of a network architecture (not shown). In such an embodiment, the network architecture may include, alone or in any suitable combination, a telephone-based network (such as a PBX or POTS), a local area network (LAN), a wide area network (WAN), a dedicated intranet, and/or the Internet. Further, the network architecture may include any suitable combination of wired and/or wireless components and systems. For example, network interface 117 may include one or more modulators, demodulators, multiplexers, demultiplexers, network communication devices, wireless devices, antennas, modems, and any other type of device configured to enable data communication via a communication network.

User computing system 110 may include a user interface 118. User interface 118 may embody an interactive software program that allows an operator of user computing system 110 to customize a secure file transfer session, initialize a file transfer process, monitor the progress of the file transfer session, and modify certain accessibility features associated with files posted to file transfer server 140. User interface 118 may also allow a user to monitor and modify certain characteristics of data files that the user has permission to access.

User interface 118 may include one or more interface modules. Each module associated with user interface 118 may be configured to define a particular function or operational aspect of a secure file transfer process. For example, user interface 118 may include a recipient selection module 119, a file selection module 120, and an access module 121. According to one exemplary embodiment, the modules may be provided in a single window associated with user interface 118, forming a respective portion of user interface 118. It is contemplated that user interface 118 may include additional, fewer, and/or different components than those listed above. For example, user interface 118 may include a progress indicator that displays the progress of a file transfer process.

Recipient selection module 119 may comprise an interactive interface that allows an operator to select one or more intended recipients of a data file to be transferred to file transfer server 140. For example, recipient selection module 119 may be linked to an electronic address database that includes a plurality of electronic messaging addresses for a plurality of potential recipients. Electronic address database may be linked for, for example, to a corporate messaging directory; an instant messaging software directory; an email database; and/or a telephone, paging, or text messaging directory. The addresses associated with the electronic message database may each be linked to a communication service for providing electronic messages (e.g., text messages, pages, emails, etc.) to a user associated with a respective address. Each electronic message address may also be linked to a file transfer account of a recipient, such that copies of transferred files are posted to the file transfer accounts of user-selected recipients of the files.

File selection module 120 may comprise an interactive interface that allows an operator to select one or more files to be transferred to file server 140. For example, file selection module 120 may be linked to database 115, storage 114, or other memory device, in which data files may be stored. File selection module 120 may be configured to allow the operator to browse through a directory of files stored in memory to select one or more files to be transferred to file server 140. The selected files may be queued in memory for uploading to file transfer server 140 during a file transfer session.

Access module 121 may comprise an interactive interface that allows an operator of user computing system 110 to monitor, access, display, record, and/or modify one or more features associated with files posted to file transfer server 140. According to one embodiment, access module 121 may include a graphical user interface that, upon authentication of a registered user, provides the operator with access to the file transfer account associated with the operator. The graphical user interface may enable the operator to perform various data management and file transfer tasks such as, for example, viewing and modifying characteristics of files that the operator has uploaded to file transfer server 140, viewing and downloading files for which the operator is listed as an intended recipient, monitoring the status of files associated with the operator's file transfer account, granting access of one or more uploaded files to additional and/or different users than those originally listed, increasing or decreasing the confidentiality level of uploaded files, and/or any other appropriate task associated with files stored on file transfer server 140.

User interface 118 may be integrated as part of an electronic messaging service. Accordingly, certain features associated with the electronic messaging service may be incorporated with user interface 118 to provide an integrated messaging tool that allows users to upload files to file transfer server 140 and transmit electronic messages to one or more intended recipients of the uploaded file. For example, user interface 118 may be integrated with an electronic mail messaging service associated with a business entity or corporation. As such, user interface 118 may be configured to upload a data file to file transfer server 140 and automatically generate and transmit an electronic mail message notifying a sender and/or one or more intended recipients that the file has been successfully uploaded. User interface 118 may also include a message interface that allows the sender to customize the electronic mail messages to be transmitted.

Communication network 130 may be any network that facilitates communication between one or more computer systems such as, for example, user computing system 110 and/or file transfer server 140. For example, communication network 130 may communicatively couple user computing system 110 to file transfer server 140 across a wired or wireless networking platform such as, for example, the Internet, cellular, Bluetooth, satellite, microwave, point-to-point wireless, point-to-multipoint wireless, multipoint-to-multipoint wireless, or any other appropriate communication platform for networking one or more remote systems. According to one embodiment, communication network 130 may include a proprietary, secure telecommunications network that supports voice, video, and data communications via the Internet, e-mail, or any other communication medium.

File transfer server 140 may include any type of computer system, server, or file database that provides a repository for storing, sharing, distributing, and accessing files by a plurality of users of file transfer environment 100. File transfer server 140 may include hardware and/or software components configured to receive data files from one or more user computing systems 110, store the data files in a file transfer account associated with the sender of the files, identify one or more intended recipients of the data files, and limit access to the stored data files only to those intended recipients specified by the sender of the file.

According to one embodiment, file transfer server 140 may be configured to monitor and record user activity associated with one or more data files. File transfer server 140 may deliver the user activity statistics to one or more registered users via access module 121 of user interface 118. For example, file transfer server 140 may monitor when an intended recipient of a particular data file has downloaded the file, record information related to the file download (e.g., download date, time, etc.), and provide the download information to user interface 118 via access module 121.

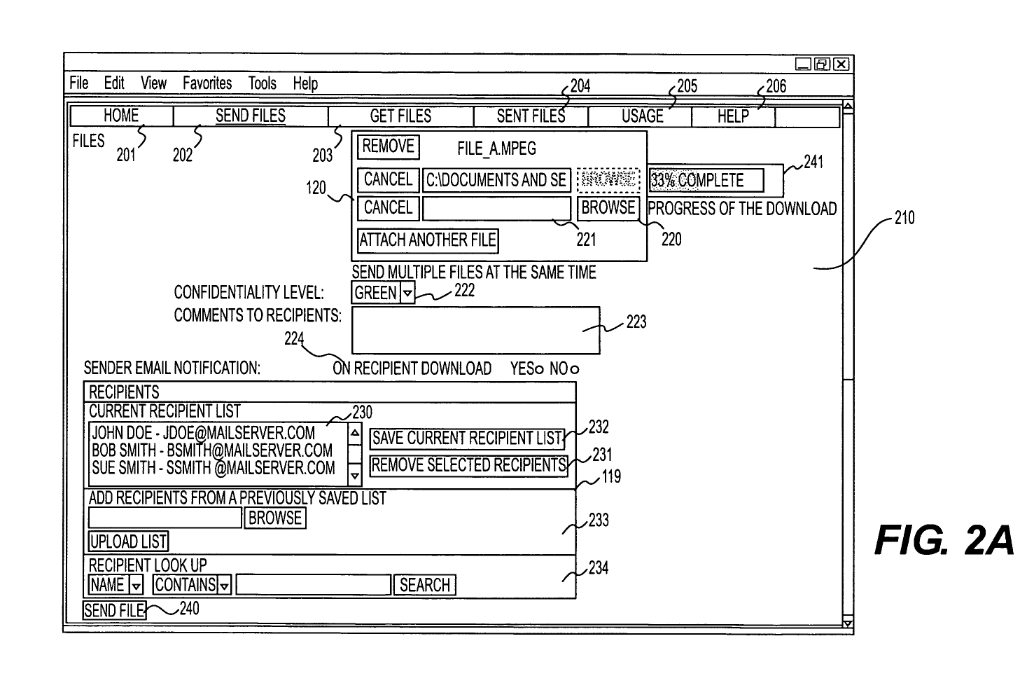

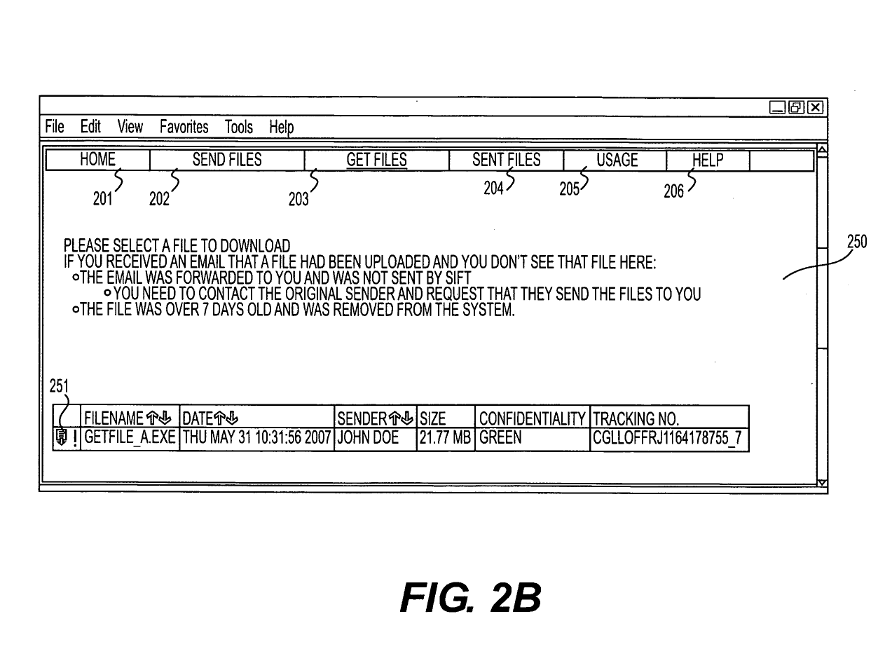

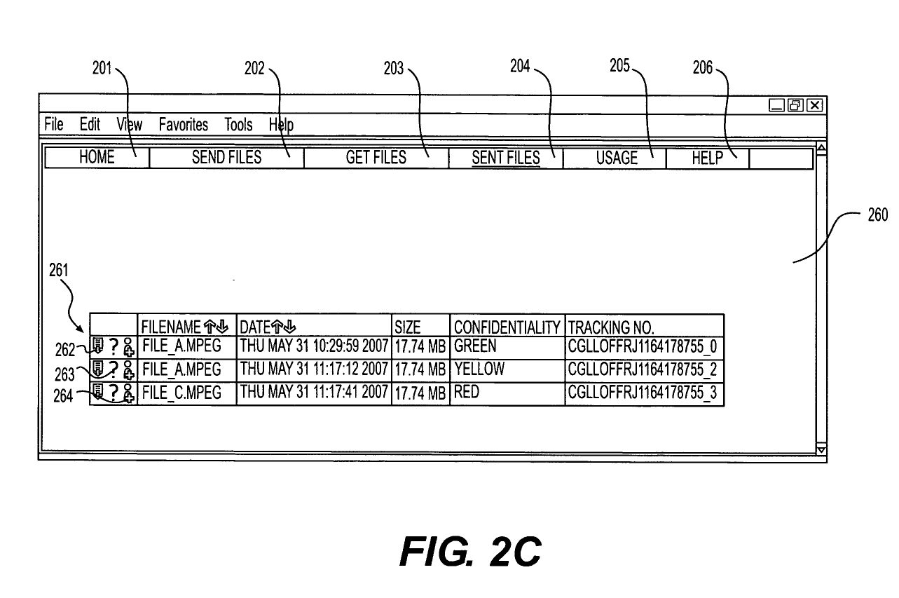

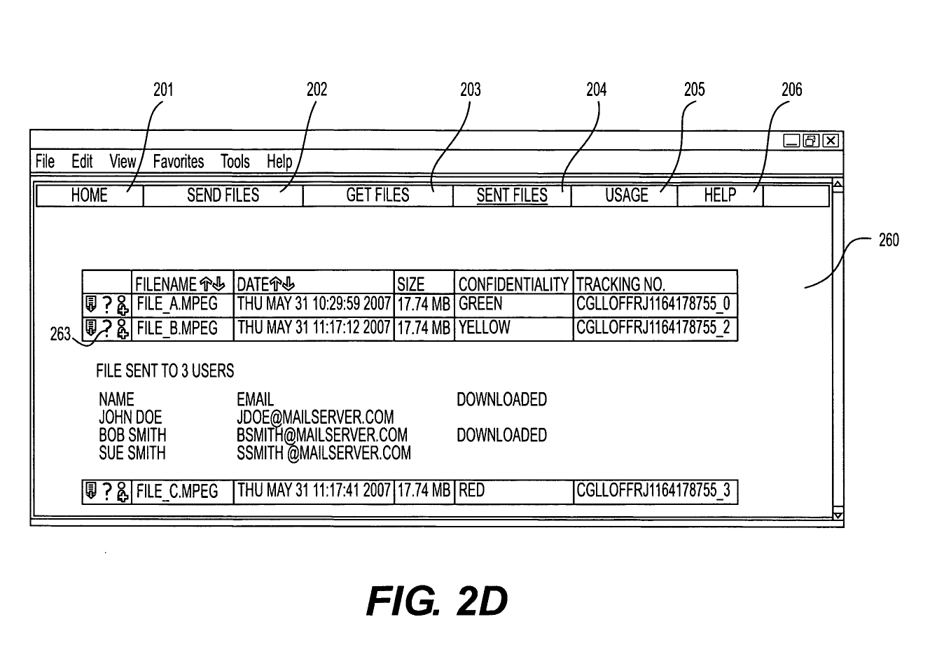

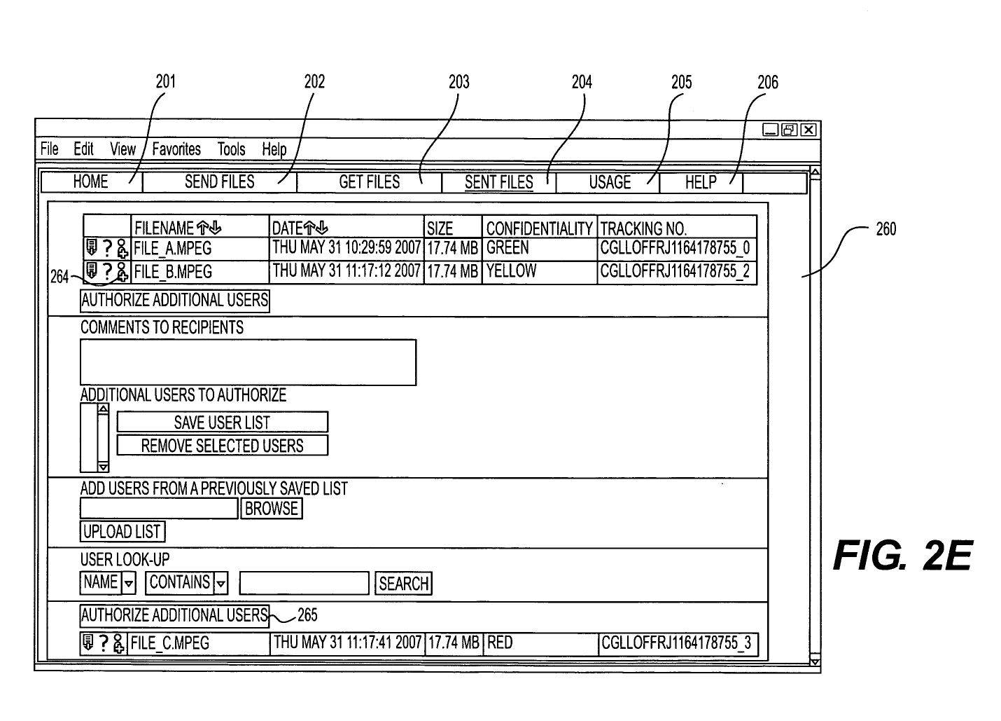

As explained, user interface 118 may include software that provides a plurality of interface modules that enable users configure the operation of file transfer environment 100. FIGS. 2A-2E provide exemplary illustrations of user interface 118 associated with user computing system 110. User interface 118 may include a plurality of tabs, each tab corresponding to a particular view that is provided to an operator of user computing system 110. For example, user interface 118 may include a “home” tab 201, a “send files” tab 202, a “get files” tab 203, a “sent files” tab 204, a “usage” tab 205, and a “help” tab 206.

“Home” tab 201 may provide a link to a main login page. The login page provides an interface that prompts an operator for a username and password, authenticates the username and password to ensure that the user is authorized to access file transfer server 140, and grants authorized access to certain features associated with file transfer server 140, based on the level of authorization provided to the user. For example, certain users may only be granted download capabilities by an administrator of file transfer environment 100. Accordingly, users may only be granted access to features of user interface 118 that correspond to the predetermined access rights established by a network administrator for downloading data files.

“Send files” tab 202 may provide a link to an interactive file transfer page 210. Interactive file transfer page 210 may include, among other things, file selection module 120 and recipient selection module 119. File selection module 120 may be linked to a file directory associated with user computing system 110. File selection module 120 allows users to select one or more files to be uploaded to file transfer server 140. File selection module 120 may include a browse button 220 that allows users to select files from a linked catalog of files stored in memory. Alternatively, file selection module 120 may include a file entry field 221 that allows users to manually enter the address or path of the file to be transferred.

Recipient selection module 119 may be linked to an electronic address directory and may be configured to allow users to select one or more intended recipients of the selected data files from the electronic address directory. Recipient selection module 119 may include a recipient display 230 that provides the name and addresses of recipients selected by the user. Users may remove intended recipients by highlighting one or more of the intended recipients listed in recipient display 230 and selecting a “remove selected recipients” button 231. Additionally, users may save a current recipient list for later user by selecting a “save current recipient list” button 232.

Recipient selection module 119 may also include a recipient retrieval portion 233 that allows users to retrieve saved recipient lists and select one or more recipients from the saved lists. For example, if a user is part of a design team that includes a plurality of users that collaborate to perform a common project, the user may create and store a list of users associated with the project. This list may be retrieved during file transfer sessions, thereby allowing users to recall the list of intended recipients, without having to individually select each recipient for every file transfer session.

Recipient selection module 119 may also include a recipient search tool 234. Recipient search tool 234 may embody database search and filtering software that allows a user to search electronic address directory for a recipient. This feature may be particularly advantageous when only limited data associated with a particular intended recipient is known.

Interactive file transfer page 210 may also be configured to allow a user to select a confidentiality level corresponding to one or more files associated with the file transfer session. For example, interactive file transfer page 210 may provide a confidentiality selection menu 222 that allows a user to select from predetermined confidentiality levels associated with the data files. Once selected, only users with appropriate clearance will be granted access to view or download the files. According to one embodiment, if the user selects one or more intended recipients that do not possess the appropriate clearance to access the files, an electronic notification may be automatically provided to the sender and the intended recipient of the file, indicating that the intended recipient was not granted access to the data file.

Interactive file transfer page 210 may also include a comment box 223 that allows users to input a customized message for distribution to one or more of the intended recipients. Comment box 223 may be linked, for example, to an electronic mail messaging system. As such, the electronic mail messaging system may automatically incorporate messages provided within comment box 223 into the body of an electronic mail message, for distribution to the one or more intended recipients of the selected data file(s).

Interactive file transfer page 210 may also include a sender email notification button 224. Sender email notification button 224 may provide users with an option for generating and transmitting an electronic mail message to the sender of the file during certain milestones of the file transfer process. For example, when selected, this option may configure user interface 118 to provide an electronic message to the sender when the file upload process has been successfully completed. Alternatively or additionally, user interface 118 may provide an electronic message notification when each of the intended recipients downloads the selected data file(s). According to another embodiment, user interface 118 may detect errors in the file transfer process and may provide an electronic message reporting the detected error to the sender.

Interactive file transfer page 210 may include a “send file” button 240 that, when actuated, allows the operator to initiate a file transfer process. For example, once customization of the file transfer options associated with interactive file transfer page is complete, the operator may begin uploading the selected data files to file transfer server 140 by pressing the “send file” button 240. In response, CPU 111 of user computing system 110 may retrieve the selected data files and place the files in a communication queue associated with network interface 117. Network interface 117 may establish an encrypted, secure communication channel with file transfer server 140 via communication network 130 and begin uploading the selected files. The uploaded files may be stored in a memory location associated with a file transfer account of the operator.

During the file transfer process, interactive file transfer page 210 may provide a progress indicator 241 that displays the progress of the file transfer progress. According to one exemplary embodiment, progress indicator 241 may provide an estimate of the percent completion of the file transfer process. It is contemplated, however, that additional and/or different indicators of the progress of the file transfer process may be provided. For example, progress indicator 241 may display an estimated time remaining to complete the file transfer process.

In addition to providing an interface for customizing and initiating secure file transfer processes, user interface 118 may also enable users to retrieve files from file transfer server 140. For example, as illustrated in FIG. 2B, “get files” tab 203 may provide a link to a download page 250 corresponding with the operator's file transfer account stored on file transfer server 140.

As explained, files are uploaded to file transfer server 140 for sharing among users. Accordingly, the one or more intended recipients provided by the sender may be granted access to the uploaded files. According to one embodiment, copies of the uploaded files may be stored in a file transfer account associated with each of the intended recipients. However, to reduce the amount of memory associated with creating and maintaining multiple instances of the same file, the file may be stored in the sender's file transfer account and a link to the file may be posted to the file transfer account corresponding to each of the intended recipients. The operator may download files from the download page by selecting a “download file” link 251, which initiates a file download process.

As illustrated in FIG. 2B, download page 250 may display data associated with files that have been uploaded by users of file transfer environment 100. For example, for each file that includes the operator as an intended recipient, download page 250 may display the filename, date, sender, size, confidentiality level, and/or tracking number. It is contemplated that additional and/or different data may be provided by download page 250. For example, download page 250 may optionally provide a list of all of the intended recipients of the file.

“Sent files” tab 203 may provide data associated with files uploaded by the operator. FIG. 2C illustrates an exemplary view of a sent files page 260 associated with user interface 118. According to one embodiment, sent files page 260 provides an interactive list 261 of files previously uploaded by the operator. The operator may interact with a portion of the list to view file transfer statistics associated with each of the files. As with download page 250 of FIG. 2B, sent files page 260 may display characteristics associated with each of the uploaded files such as, for example, a filename; a day, date, and time associated with the file upload; a size of the file; a confidentiality level associated with the file; and/or a file tracking number.

Sent files page 260 may also include one or more interactive links 261 for viewing certain aspects of the uploaded files. Interactive links 261 may include, for example, a “remove file” link 262 configured to allow the operator to remove or delete recipient access of the uploaded file, a “details” link 263 configured to display detailed information associated with a particular file, and a “modify” link 264 configured to allow the operator to modify certain features associated with the uploaded file.

“Deletion notification” tab 262 may display information related to the when the file is scheduled for removal or deletion from the system. It is contemplated that “deletion notification” screen may be automatically displayed upon operator login, notifying the user when one or more files are scheduled for deletion. Deletion notification information may be provided as a listing of the files and a corresponding scheduled deletion date for each file. According to one embodiment, a deletion notification warning may be provided when the file is scheduled for deletion within a predetermined time period. For instance, “deletion notification” tab 262 may only be displayed when the file is scheduled for deletion within 48 hours. Alternatively or additionally, when the file is scheduled for deletion within the predetermined time period, “deletion notification” tab 262 may change from a default icon (e.g., of a neutral color) to a warning icon (e.g., of a alternate color).

As explained, “details” link 263 may be configured to display information associated with the selected file. FIG. 2D illustrates an exemplary view associated with “details” link 263. As illustrated in FIG. 2D, “details” tab 263 may, when selected, display the names and electronic messaging address corresponding to each of the intended recipients of the file. Next to the name and address of each intended recipient, the download status of the file for each recipient may be displayed. For example, as shown in FIG. 2D, the file named “File_A.mpeg” has only been downloaded by Bob Smith, one of the three intended recipients of the file. As additional recipients download the file, the data associated with “details” link 263 may be updated to enable real-time or near real-time tracking of file transfer data.

“Modify” link 264 may be configured to allow the operator to modify certain accessibility features associated with files after they have been uploaded to file transfer server 140. This modification feature may enable users to add and remove recipients and/or modify the confidentiality level associated with an uploaded file, without requiring the operator to re-upload the file. This feature is also configured to notify one or more of the affected recipients of changes to file accessibility associated with the modifications.

As illustrated in FIG. 2E, “modify” link 264 of user interface 118 may provide a screen similar to recipient selection module 119 of FIG. 2A. Here, the operator may add and remove intended recipients and provide updated comments to the added recipients. Once the appropriate changes have been established, the operator may select an “authorize additional users” button 265 that updates the file transfer accounts associated with each intended recipient. Once the updates have been made, user interface 118 may cause CPU 111 to execute messaging software that generates an electronic message (e.g., e-mail, text message, etc.) summarizing the modifications to the files. The generated message may subsequently be delivered to one or more of the intended recipients.

“Usage” tab 204 may provide a view (not shown) of an activity log corresponding with the operator currently logged in to user computing system 110. According to one embodiment, file transfer server 140 may record certain operator interactions with user interface 118 in a table stored in the operator's file transfer account. For example, file transfer server 140 may record a date and time that the operator downloads or uploads a particular data file. Alternatively or additionally, file transfer server 140 may record the address (e.g., IP address, MAC address, network address, etc.) corresponding to the computer system from which the file transfer was initiated. According to another example, file transfer server 140 may log modifications to features associated with files stored in the operator's file transfer account (e.g., modifications to an intended recipient list, modifications to a confidentiality level, etc.) “Usage” tab 204 may be linked to the table and configured to display usage activity of the operator.

“Help” tab 205 may provide a link to a searchable product assistance manual, an interactive assistance tool, a helpdesk website, a knowledge database, or any other medium for assisting the operator with performing tasks or using features associated with user interface 118.

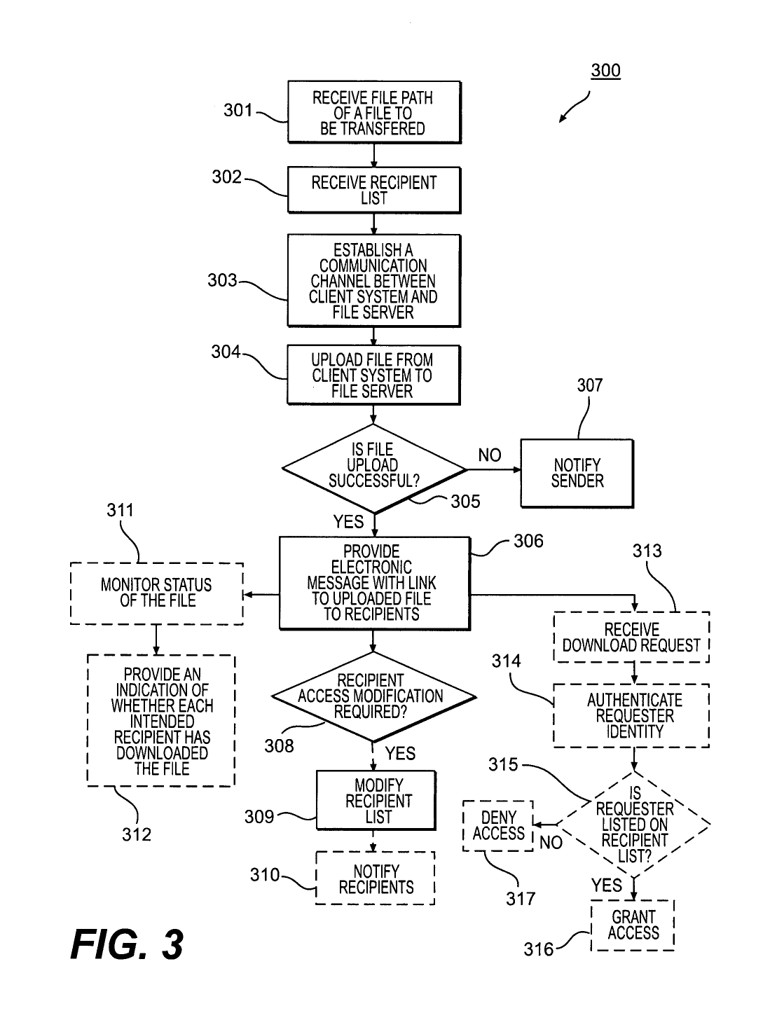

Processes and methods consistent with the disclosed embodiments provide a file transfer solution that allows users to securely and efficiently share and access files using a common server, such as file transfer server 140. Features associated with certain embodiments provide a single interactive user interface that allows users to define file transfer parameters, monitor the transfer of data between user computing system 110 and file transfer server 140, monitor recipient access to files transferred by the user, download files transferred by other users, and modify accessibility features for previously uploaded or transferred files, without requiring separate interfaces or software programs. FIG. 3 provides a flowchart 300 depicting an exemplary method for transferring files between a client system and a file server using user interface 118.

As illustrated in FIG. 3, the method may include receiving an address of a file to be transferred/uploaded (Step 302). For example, user interface 118 may be linked to a file directory or storage database associated with user computing system 110, which includes a listing of files stored on user computing system 110 that are available for uploading to file transfer server 140. User interface 118 may provide a browse function that allows a user to search for files in the file directory and select one or more of the files for uploading to file server and sharing with a plurality of designated recipients.

The method may also include receiving a list of intended recipients of a file to be transferred/uploaded (Step 301). For example, user interface 118 may be linked to an electronic directory that includes a listing of a plurality of members or employees of an organization. User interface 118 may provide the listing to an operator of user computing system 110 and receive/detect operator selections from the listing. User interface 118 may compile a list of intended recipients based on the received operator selection. According to one embodiment, user interface 118 may provide an option that allows the operator to store lists of users in memory, for later retrieval.

Once files and users associated with a file transfer session have been received, user interface 118 may receive and/or collect any optional file transfer settings established by the user. For example, user interface 118 may receive user designations of the confidentiality level associated with a file to be transferred. According to one embodiment, user interface 118 may assign a minimum (default) confidentiality level to each file. Users may modify the default level by selecting a different confidentiality level from a predetermined list.

User interface 118 may update the recipient list based on the user-designated confidentiality level. For example, if one or more intended recipients on the recipient list do not have the appropriate confidentiality “clearance” to view the selected file, the recipient may be removed from the recipient list. According to one embodiment, user interface 118 may provide an alert or warning indicator notifying the user that the selected confidentiality level may exclude one or more of the selected intended recipients. This warning may prevent a user from inadvertently excluding one or more of the intended recipients.

User interface 118 may also receive comments or text messages to be delivered to one or more intended recipients. For example, user interface 118 may receive text input within a comment window of user interface 118. During a file transfer session, the text may be imported and posted with the uploaded file. Alternatively or additionally, the text may be incorporated within an electronic message and delivered to the intended recipient as part of the file transfer process.

Once the user has completed customization of the file transfer session (by initiating the “send files” command), user interface 118 may establish a communication channel between user computing system 110 and file transfer server 140 (Step 303). According to one embodiment, when the user selects the “send files” command, user interface 118 causes CPU 111 to initialize a file transfer process by causing network interface 117 to establish a secure, encrypted communication link with file transfer server 140.

Upon establishing a secure communication channel with file transfer server 140, network interface 117 may upload the user-selected files in accordance with the options and settings selected by the user (Step 304). According to one embodiment, file transfer server 140 may identify and authenticate the user, using, for example, an IP address or MAC address of user computing system 118 and/or login ID and password corresponding with the user. The selected file(s) may then be uploaded to a file transfer account associated with the user. Each uploaded file may be stored with the corresponding recipient list selected by the user.

During the file transfer process, user interface 118 may display the progress of the file upload process. For example, network interface 117 may estimate the ratio of data uploaded to file transfer server 140 to the total amount of data to be uploaded. Network interface 117 may provide this data to user interface 118, which may provide a graphical indicator that displays the progress of the file upload process.

Optionally, user interface 118 may monitor the status of the file transfer process to determine if the file(s) are successfully uploaded to file transfer server 140 (Step 305). For example, user interface 118 may detect errors in file uploaded to the file transfer server 140. According to one embodiment, interactive interface may determine if a connection between user computing system 110 and file transfer server 140 is interrupted during a file upload process. Alternatively, user interface 228 may determine if a connection between user computing system 110 and file transfer server 140 is unavailable (e.g., if file transfer server 140 cannot be located, etc.) User interface 118 may flag these file upload errors and report the errors to the sender and intended recipients of the data file(s).

According to one exemplary embodiment, user interface 118 may monitor the status of the upload request in a communication queue of network interface 117, to determine if the upload process is completed in a timely manner. For instance, if the upload request is not completed within a predetermined time period, or if the communication queue becomes backlogged (which may be indicative of communication errors), user interface 118 may notify the sender and/or intended recipients of the file(s).

If the file upload process is successful, user interface 118 may notify the intended recipients and provide an interactive link to the uploaded file to each of the intended recipients (Step 306). According to one embodiment, user interface 118 may automatically generate an electronic message (e.g., electronic mail, text message, etc.), notifying the one or more intended recipients that a new file is available for download. The electronic message may include a secure, interactive link to the location of the file on file transfer server 140. As explained, uploaded files are located in a database storage location corresponding to a file transfer account of the user. The electronic message includes the interactive link to the database storage location of the user. Each intended recipient is identified and authenticated using the recipient list stored with the file to ensure that the person requesting the file is authorized by the sender to view the file. Accordingly, if the electronic message is forwarded to an unauthorized recipient by one or more of the authorized intended recipients, the unauthorized recipient will not be permitted to view the file.

According to another embodiment, user interface 118 may post a link to the uploaded file to the file transfer account of each of the intended recipients. For example, once uploaded, a link to the file may be posted to the file transfer account of each intended recipient on the recipient list. Intended recipients may access this link through the “get files” tab 203 of user interface 118.

If, on the other hand, the file upload process is unsuccessful or is not completed within a predetermined time period, user interface 118 may automatically generate an electronic message, notifying the sender that one or more of the files have not been successfully uploaded to file transfer server (Step 307). By notifying the sender of unsuccessful or erroneous file transfers immediately upon detection, the sender may be able to take the appropriate measures to correct the error.

Once the file has been successfully uploaded, file transfer server 140 may be configured to receive download requests for the uploaded file(s) from one or more requesters (Step 313). In response to the requests, file transfer server 140 may authenticate the identity of the requester (Step 314). For example, if the request comes from a logged in user of file transfer server 140 via a “get files” pages of the user, file transfer server 140 may grant access to the file by default, as links to files displayed on a user's get files page include only those files for which the user is listed as an intended recipient. If, on the other hand, the file transfer request comes from a requester that has not logged in (e.g., from a requester interaction with an e-mail link), file transfer server 140 may prompt the requester enter an authorization username and password. File transfer server 140 may determine whether a valid username and password has been entered and authenticate a user's identity corresponding to the username and password. If a valid username and password is not entered, the requester of the file(s) is denied access.

Once a requester has been identified as a registered user, file transfer server 140 may determine whether the user is listed as an intended recipient of the file (e.g., by checking the recipient list corresponding to the file) (Step 315). If the user is listed as an intended recipient (Step 315: Yes), file transfer server 140 may grant access to the requested file (Step 316). If, however, the user is not listed as an intended recipient (Step 315: No), file transfer server 140 may deny access to the requested file (Step 317).

Processes and features of user interface 118 may provide a solution that allows a sender of an uploaded file to modify the recipient list associated with the uploaded file, without requiring the sender to re-upload the file. For example, a sender of the file may determine that recipient access modification of a file may be required (Step 308). Accordingly, the sender may access the “sent files” tab 204 to display a list of files uploaded by the sender. The sender may then select “modify” link 264 associated with file whose recipient list is to be modified. “Modify” link 264 may display a recipient selection module that allows the sender to add and/or remove one or more of the recipients associated with the file (Step 309).

Once the desired changes to the recipient list have been made, the user may update the recipient list associated with the file. Accordingly, file transfer accounts associated with recipients that have been added and/or removed may be updated, whereby an interactive link to the file may be provided to added users, while the interactive link to the file may be removed or disassociated with removed users.

Alternatively or additionally, upon updating the recipient list associated with an uploaded file, user interface 118 may notify the recipients that have been added and/or removed from the recipient list. For example, user interface 118 may automatically generate and transmit an electronic message (e.g., e-mail, text message, etc.) to the recipients added to the recipient list. The electronic message may include the interactive link to the uploaded file and/or a link to a “get files” page associated with the intended recipient, for accessing, displaying, and/or downloading the file.

In addition to providing users with an interface for securely sharing files across a remote network, user interface 118 may allow a sender to monitor the status of one or more files uploaded to file transfer server 140 (Step 311). For example, user interface 118 may check a file access log associated with the users file transfer account to determine which of the one or more intended recipients have downloaded the file(s) uploaded by the sender. User interface 118 may provide an indication of whether each recipient has downloaded the file to the sender of the file. For example, interactive interface may be configured to provide an electronic message (e.g., e-mail, text message, etc.) to the sender when an intended recipient downloads a file (Step 312). Alternatively or additionally, user interface 118 may display the notification in the “sent files” view under “details” link 263, as illustrated in FIG. 2E.

In addition to providing notifications when a recipient has downloaded a file, user interface 118 may provide an error notification to the sender of a file, if the user has failed to download the file within a predetermined time period. For example, if an uploaded file has not been downloaded by one or more intended recipients within 7 days, user interface 118 may generate an error notification indicating which intended recipients have not yet downloaded the file.

### INDUSTRIAL APPLICABILITY

Although processes and methods associated with the disclosed embodiments are described in relation to secure file transfer and file sharing between a user computing system and a centralized file transfer server, the disclosed embodiments may be implemented in any network environment that includes a plurality of computer systems. The systems and methods described herein provide users with a simple file transfer software module that allows users to select file(s) to be transferred, select a plurality of intended recipients to receive the selected file(s), customize certain characteristics associated with the file transfer process, access shared files available to the user, and modify a recipient list, all within a single display window. Further, users may be able to modify access characteristics (e.g., intended recipient lists, confidentiality level, etc.) associated with uploaded files, without requiring the user to re-upload the file(s).

The presently disclosed system and method for secure file transfer may have several advantages. For example, the secure file transfer described here is configured as a single graphical interface software application that allows users to customize a file transfer session, establish a secure communication channel with a file transfer server, monitor the progress of the file transfer session, access files associated with the user, monitor the download status of uploaded files, and modify the recipient list. Accordingly, the presently disclosed secure file transfer system may reduce or eliminate the need for users to manage separate windows or software applications for performing secure file sharing and data management processes as required by some conventional file transfer systems.

It will be apparent to those skilled in the art that various modifications and variations can be made to the presently disclosed system and method for secure file transfer. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A method for transferring files between a client system and a file server comprising:
receiving, by a user interface of the client system, a location associated with at least one data file to be uploaded to a file server;
receiving, by the user interface, a recipient list that includes an electronic address associated with at least one intended recipient of the at least one data file;
establishing a communication channel between the client system and the file server;
uploading the at least one data file to a file transfer account associated with one or more of a sender or the at least one intended recipient of the at least one data file;
providing an electronic message to the electronic address associated with the at least one intended recipient, the electronic message including an interactive link to the uploaded file; and
modifying, by the user interface, the recipient list associated with the at least one data file after the at least one data file has been uploaded to the file transfer server, in response to a sender modification request.

2. The method of claim 1, wherein the recipient list may be modified without requiring the sender to re-upload the at least one data file.

3. The method of claim 1, further including:
determining whether the at least one intended recipient has downloaded the at least one data file; and
providing a download notification to the sender if the at least one intended recipient has downloaded the at least one data file.

4. The method of claim 3, further including providing an error notification to the sender if the at least one intended recipient has failed to download the at least one data file within a predetermined time period.

5. The method of claim 3, further including providing an error notification to the sender if the at least one intended recipient receives an error while attempting to download the at least one data file.

6. The method of claim 1, wherein uploading the at least one data file includes transmitting a second electronic message to the electronic address associated with the at least one intended recipient, the electronic message including an indication that the at least one data file has been uploaded to the file transfer server.

7. The method of claim 1, further including receiving a user-defined confidentiality level associated with the at least one data file, the method further comprising:
determining, based on the user-defined confidentiality level, whether the at least one intended recipient is authorized to access the at least one data file;
removing the at least one intended recipient from the recipient list if the at least one intended recipient is not authorized to access the at least one data file; and
providing a removal notification to one or more of the sender and the at least one intended recipient, in response to the removing of the at least one intended recipient from the recipient list.

8. The method of claim 1, wherein the interactive link to the uploaded data file is accessible only by the sender and the at least one intended recipient.

9. The method of claim 1, further including:
receiving, by the file transfer server, a download request associated with the at least one data file;
authenticating an identity of a requester of the file;
granting access to the at least one data file to the requester if the requester of the file is listed on the intended recipient list; and
denying access to the at least one data file to the requester if the requester of the file is not listed on the intended recipient list.

10. The method of claim 1, wherein modifying the recipient list includes:
adding an additional intended recipient of the at least one data file after the at least one data file has been uploaded to the file transfer server; and
transmitting a second electronic message to the additional intended recipient, the second electronic message including the interactive link to the uploaded file.

11. A computer-readable medium for use on a computer system, the computer-readable medium including computer-executable instructions for performing the method of claim 1.

12. A file transfer interface comprising:
a file selection portion communicatively coupled to a file database associated with a user computing system and configured to allow a user to select at least one data file to be uploaded to a file transfer server;
a recipient selection portion communicatively coupled to an electronic messaging directory and configured to allow the user to create, from the electronic messaging directory, a recipient list that includes at least one intended recipient of the at least one data file;
an access portion communicatively coupled to the file transfer server and configured to:
display files uploaded by the user to the file transfer server;
modify the recipient list associated with one or more files after the one or more files have been uploaded to the file transfer server, in response to a user command; and
display a status of each of the files uploaded by the user.

13. The interface of claim 12, wherein the recipient selection portion, the file selection portion, and the access portion are provided in a single window of the file transfer interface.

14. The interface of claim 12, wherein the file transfer interface is configured to:
initiate a secure file transfer process whereby the at least one data file selected by the file selection portion is transferred from the user computing system to the file transfer server;
monitor progress of the secure file transfer process; and
transmit a file transfer notification to an electronic address associated with at least one of the user and the intended recipient of the at least one data file, upon successful completion of the secure file transfer process.

15. The interface of claim 14, wherein the file transfer notification includes an interactive link to the uploaded file.

16. The interface of claim 15, wherein modifying the recipient list includes:
adding an additional intended recipient of the at least one data file after the file has been uploaded to the file transfer server, in response to a recipient modification request from the user; and
transmitting an electronic message to the at least one additional recipient, the electronic message including the interactive link to the uploaded file.

17. The interface of claim 14, wherein displaying the status of the files posted to the file transfer server includes determining whether the files posted to the file transfer server have been downloaded by one or more of the intended recipients.

18. The interface of claim 17, wherein monitoring the status of the files posted to the file transfer server further includes:
displaying the list of files posted by the user;
displaying a list of intended recipients associated with each file; and
displaying an indication of whether each intended recipient has downloaded a respective file.

19. The interface of claim 12, wherein the file selection portion includes a file transfer progress indicator, the file transfer progress indicator configured to:
monitor an amount of data transferred from the user computing system to the file transfer server during a file transfer session; and
display a progress bar indicative of the amount of data transferred from the user computing system to the file transfer server.

20. The interface of claim 12, wherein the file transfer portion further includes a confidentiality level selector configured to:
provide a plurality of user-selectable file confidentiality levels associated with the selected files to be posted to the file transfer server; and
modify the recipient list based on the file confidentially level selected by the user.

21. The interface of claim 20, wherein modifying the recipient list includes:
comparing the file confidentiality level selected by the user with a confidentiality level associated with the at least one intended recipient; and
removing the at least one intended recipient if the confidentiality level associated with the at least one intended recipient is incompatible with the file confidentiality level.
